(19) United States
(12) Patent Application Publication
(10) Pub. No.: US 2022/0319528 A1
(43) Pub. Date: Oct. 6, 2022

(54) METHOD AND ELECTRONIC DEVICE FOR SUPPRESSING NOISE PORTION FROM MEDIA EVENT

(71) Applicant: Samsung Electronics Co., Ltd., Suwon-si (KR)

(72) Inventors: Prasenjit CHAKRABORTY, Karnataka (IN); Bhavin SHAH, Karnataka (IN); Siddhesh Chandrashekhar GANGAN, Karnataka (IN); Vinayak GOYAL, Karnataka (IN); Srinidhi N, Karnataka (IN)

(21) Appl. No.: 17/716,648

(22) Filed: Apr. 8, 2022

Related U.S. Application Data
(63) Continuation of application No. PCT/KR2022/004537, filed on Mar. 30, 2022.

(30) Foreign Application Priority Data
Mar. 31, 2021 (IN) 202141015359
Mar. 23, 2022 (IN) 2021 41015359

(51) Int. Cl. G10L 21/0216; G10L 21/0232; G10L 21/0272

(52) U.S. Cl. CPC G10L 21/0216; G10L 21/0232; G10L 21/0272; G10L 2021/02087

(57) ABSTRACT

A method for suppressing a noise portion(s) from a media event by an electronic device is provided. The method includes receiving a voice signal comprising the noise portion(s) and a voice(s) during the media event. Further, the method includes determining a weightage(s) for the noise portion(s) throughout the media event. Further, the method includes determining a plurality of parameters associated with the electronic device, where the plurality of parameters comprises at least one of a preference(s) of a user of the electronic device or a current context of the electronic device. Further, the method includes suppressing the noise portion(s) in the voice signal based on the weightage(s) and the plurality of parameters associated with the electronic device. Further, the method includes generating a media file, where the media file includes the voice(s) and non-suppressed noise portion(s).

### CROSS-REFERENCE TO RELATED APPLICATION(S)

This application is a continuation application, claiming priority under § 365(c), of an International application No. PCT/KR2022/004537, filed on Mar. 30, 2022, which is based on and claims the benefit of an Indian Provisional patent application number 202141015359, filed on Mar. 31, 2021, in the Indian Intellectual Property Office, and of an Indian Complete patent application number 202141015359, filed on Mar. 23, 2022, in the Indian Intellectual Property Office, the disclosure of each of which is incorporated by reference herein in its entirety.

### FIELD OF INVENTION

The disclosure relates to an electronic device. More particularly, the disclosure relates to a method and the electronic device for suppressing a noise portion from a media event.

### BACKGROUND

Background noise is often referred to as ambient noise. Any disturbance other than a primary sound (e.g. human voice) being monitored is referred to as the background noise. The background noise includes environmental disturbances such as the sound of water flowing, wind, vehicles, appliances, machineries, alarms, extraneous voices, etc. The background noise is an important factor to consider in any communication (e.g. voice call, video call, recording event, etc.), as the background noise during the communication degrades a user's auditory experience.

A certain existing method provides a noise cancellation feature in an electronic device for filtering-out or removing the background noise from the primary sound such as a speech, which improves user's auditory experience. But the noise cancellation feature fails to enhance the user's auditory experience if any non-speech sounds such as a music or karaoke is an important part of the communication, in which the noise cancellation feature considers the non-speech sounds as the background noise and filers it out. In this scenario, the noise cancellation feature needs to be turned off manually.

The existing noise cancellation feature uses a static definition (e.g. all sounds other than the primary sound serve as the background noise) of the background noise, whereas in a real-time scenario, a definition of the background noise is dynamic. For example, a voice of a wailing baby acts as the background noise for an official meeting call, whereas for a family meeting call the voice of the wailing baby acts as the primary sound. In another case, the sound of an animal is the primary sound for a zoophilist whereas the same sound is the background noise for a typical user. The existing method does not provide a choice to a user for selecting the sound to utilize as the primary sound or the background noise. Thus, it is desired to provide a useful solution for selectively suppressing the background noise from any communication.

The above information is presented as background information only to assist with an understanding of the disclosure. No determination has been made, and no assertion is made, as to whether any of the above might be applicable as prior art with regard to the disclosure.

### OBJECT OF INVENTION

Aspects of the disclosure are to address at least the above-mentioned problems and/or disadvantages and to provide at least the advantages described below. Accordingly, an aspect of the disclosure is to provide an electronic device for suppressing a noise portion(s) selectively from a media event (e.g. voice call, video call, recording event, etc.) based on a weight(s) for each noise portion. The weight(s) for each noise portion is updated based on a plurality of parameters associated with the electronic device. The plurality of parameters includes, but is not limited to, a preference of a user of the electronic device, and a current context of the electronic device. As a result, user's auditory experience is enhanced during the media event.

Additional aspects will be set forth in part in the description which follows and, in part, will be apparent from the description, or may be learned by practice of the presented embodiments.

### SUMMARY

In accordance with an aspect of the disclosure, a method for suppressing a noise portion(s) from a media event (e.g. voice call, video call, etc.) by an electronic device is provided. The method includes receiving, by the electronic device, a voice signal comprising the noise portion(s) and a voice(s) during the media event. Further, the method includes determining, by the electronic device, a weightage(s) for the noise portion(s) throughout the media event. Further, the method includes determining, by the electronic device, a plurality of parameters associated with the electronic device, where the plurality of parameters comprises at least one of a preference(s) of a user of the electronic device or a current context of the electronic device. Further, the method includes suppressing, by the electronic device, the noise portion(s) in the voice signal based on the weightage(s) and the plurality of parameters associated with the electronic device. Further, the method includes generating, by the electronic device, a media file (e.g. audio file, audio stream, video file, video stream, etc.), and where the media file includes the voice(s) and non-suppressed noise portion(s).

In an embodiment, where the suppressing, by the electronic device, of the noise portion(s) in the voice signal based on the weightage(s) and the plurality of parameters associated with the electronic device includes updating, by the electronic device, the determined weightage(s) for each noise portion based on the plurality of parameters, and suppressing, by the electronic device, the noise portion(s) in the voice signal based on the updated weightage(s) and the plurality of parameters associated with the electronic device.

In an embodiment, the preference of the user of the electronic device includes a behavior of the user of the electronic device and a user input of the electronic device, and the current context of the electronic device includes location information, audio information, and visual information present in the media event.

In an embodiment, the current context of the media event is determined by an artificial intelligence (AI) model(s).

In an embodiment, where the determining, by the electronic device, of the weightage(s) for the noise portion(s) throughout the media event includes detecting, by the electronic device, the noise portion(s) occurring throughout the media event, mapping, by the electronic device, the noise portion(s) occurring throughout the media event to one or more noise category, assigning, by the electronic device, the weightage(s) for each noise portion of the determined noise portion(s) based on a pre-loaded weightage(s) and the mapping, where the pre-loaded weightage(s) is stored in a database of the electronic device.

In an embodiment, where the suppressing, by the electronic device, of the noise portion(s) in the voice signal based on the weightage(s) and the plurality of parameters associated with the electronic device includes performing one of, increasing a value of the weightage(s) for the noise portion(s) based on the plurality of parameters associated with the electronic device, or decreasing the value of the weightage(s) for the noise portion(s) based on the plurality of parameters associated with the electronic device, or increasing or decreasing the value of the weightage(s) for the noise portion(s) based on the mapping and the pre-loaded weightage(s). Further, the method includes suppressing, by the electronic device, the noise portion(s) based on the increased or decreased value of the weightage(s) by one of, suppressing the noise portion(s) when the value of the weightage(s) for the noise portion(s) is below a predefined threshold, or suppressing the noise portion(s) based on a user input of the electronic device, where the user input enables or disables the noise portion(s) and a list of the noise portion(s) and the voice(s) is displayed on a screen of the electronic device.

In an embodiment, the user input has a highest priority followed by the location information, followed by the audio information, and the visual information of the media event, followed by the user behavior.

In an embodiment, the method includes passing, by the electronic device, the noise portion(s) when the value of the weightage(s) for the noise portion(s) is above the predefined threshold, and merging, by the electronic device, the passed noise portion(s) with the voice(s).

In an embodiment, the method includes updating by the electronic device, the value of the weightage(s) for the noise portion(s) based on the plurality of parameters, and storing, by the electronic device, the updated value of the weightage(s) for the noise portion(s) in the database of the electronic device.

In an embodiment, the voice(s) includes a human voice and a non-human voice and the noise portion(s) includes the non-human voice (e.g. sound of machinery, musical instrument, etc.), a mixture of human voices, an ambience noise of an office, an ambience noise of a restaurant, an ambience noise of a home and an ambience noise outdoors on a city street.

In accordance with another aspect of the disclosure, an electronic device for suppressing the noise portion(s) from the media event is provided. The electronic device includes an intelligent noise suppressor coupled with a processor and a memory. The intelligent noise suppressor receives the voice signal comprising the noise portion(s) and the voice(s) during the media event. Further, the intelligent noise suppressor determines the weightage(s) for the noise portion(s) throughout the media event. Further, the intelligent noise suppressor determines the plurality of parameters associated with the electronic device, where the plurality of parameters includes at least one of the preference(s) of the user of the electronic device or the current context of the electronic device. Further, the intelligent noise suppressor suppresses the noise portion(s) in the voice signal based on the weightage(s) and the plurality of parameters associated with the electronic device. Further, the intelligent noise suppressor generates the media file, where the media file includes the voice(s) and non-suppressed noise portion(s).

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIGS. 1A and 1B illustrate example scenarios in which a user of an existing electronic device encounters difficulty with an existing noise cancellation feature of the existing electronic device, according to the related art;

FIG. 2 illustrates a block diagram of an electronic device for suppressing a noise portion(s) from a media event, according to an embodiment of the disclosure;

FIG. 3 is a flow diagram illustrating a method for suppressing the noise portion(s) from the media event, according to an embodiment of the disclosure;

FIGS. 4A and 4B are example flow diagrams illustrating the method for suppressing the noise portion(s) from an ongoing call by utilizing an artificial intelligence (AI) model of the electronic device, according to various embodiments of the disclosure;

FIG. 5A illustrates a block diagram of a context recognizer of the electronic device for determining a category of the noise portion(s) and a sentiment associated with a current context of the electronic device, according to an embodiment of the disclosure;

FIGS. 5B, 5C, and 5D are example scenarios illustrating functionality of the context recognizer, according to various embodiments of the disclosure;

FIGS. 6 and 7 are example scenarios illustrating a weight(s) generation for each noise portion based on a preference of the user of the electronic device, and a current context of the electronic device, according to various embodiments of the disclosure;

FIG. 8 illustrates an example scenario(s) in which at least one of the electronic device or the user of the electronic device suppress the noise portion(s) from the media event, according to an embodiment of the disclosure.

Throughout the drawings, it should be noted that like reference numbers are used to depict the same or similar elements, features, and structures.

### DETAILED DESCRIPTION OF INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Throughout this disclosure, the terms “database” and “memory” are used interchangeably, where the database is part of the memory. Throughout this disclosure, the terms “display” and “screen” are used interchangeably and mean the same. Throughout this disclosure, the terms “noise” and “noise portion” are used interchangeably and mean the same. Throughout this disclosure, the terms “weight” and “weightage” are used interchangeably and mean the same. Throughout this disclosure, the terms “screen” and “display” are used interchangeably and mean the same.

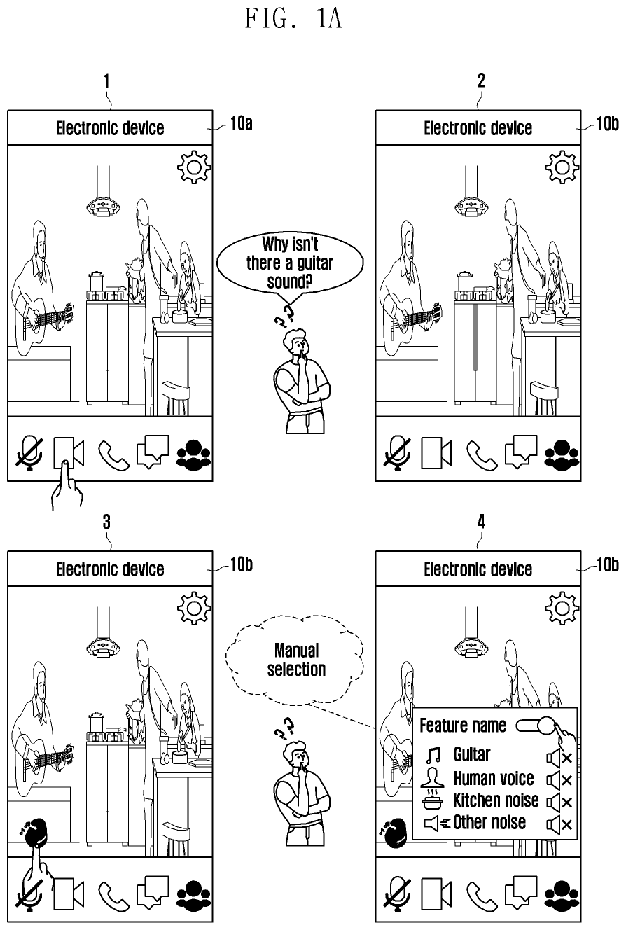

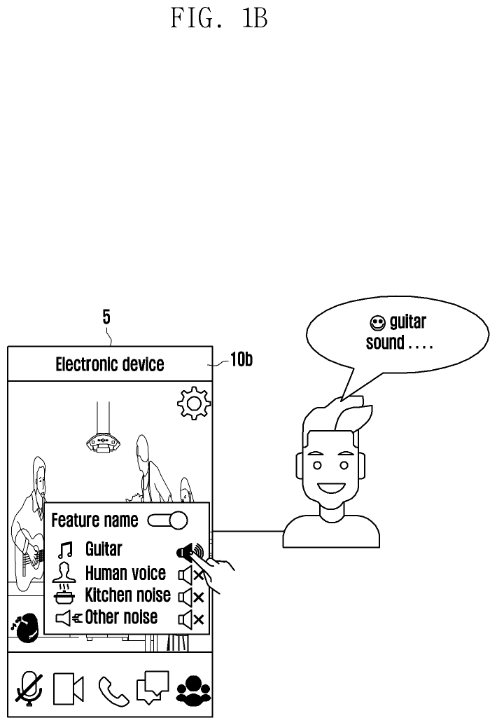

FIGS. 1A and 1B illustrate example scenarios in which a user of an existing electronic device (10a and 10b) encounters difficulty with an existing noise cancellation feature of the existing electronic device, according to the related art.

Consider following scenarios (1, 2) in which a first user of the existing electronic device (10a) records a live event (e.g. playing guitar at home). The first user wishes to share the live event with a second user of the existing electronic device (10b) through a video call. However, due to the existing noise cancellation feature of the existing electronic device (10b), the second user was unable to enjoy the live event as the noise cancellation feature mutes a desired sound (e.g. human voice with guitar sound).

To enjoy the live event (3), the second user must disable the noise cancellation feature in the existing electronic device (10b), which allows the second user to hear the desired sound with other undesired sounds (e.g. kitchen noise), resulting in a poor auditory experience for the second user.

To enjoy the live event (4, 5), certain existing methods provide a manual sound selection feature(s) in the existing electronic device (10b), where the second user has to manually select sound from a list of sounds (e.g. guitar, human voice, kitchen noise, other noise, etc.) displayed on a screen of the existing device (10b). So, based on the user selecting a particular sound (i.e. guitar) does not mute by the existing electronic device (10b), which is a time-consuming operation that results in a bad user experience. The manual sound selection feature(s) may be difficult to master or overwhelming for some users who are unfamiliar with at least one of technology or languages such as English. So, the existing electronic devices (10a and 10b) lack an intelligent method or system for suppressing unwanted sounds.

Accordingly, embodiments herein disclose a method for suppressing a noise portion(s) from a media event (e.g. voice call, video call, etc.) by an electronic device. The method includes receiving, by the electronic device, a voice signal comprising the noise portion(s) and a voice(s) during the media event. Further, the method includes determining, by the electronic device, a weightage(s) for the noise portion(s) throughout the media event. Further, the method includes determining, by the electronic device, a plurality of parameters associated with the electronic device, where the plurality of parameters comprises a preference(s) of a user of the electronic device and a current context of the electronic device. Further, the method includes suppressing, by the electronic device, the noise portion(s) in the voice signal based on the weightage(s) and the plurality of parameters associated with the electronic device. Further, the method includes generating, by the electronic device, a media file, where the media file includes the voice(s) and non-suppressed noise portion(s).

Accordingly, embodiments herein disclose the electronic device for suppressing the noise portion(s) from the media event. The electronic device includes an intelligent noise suppressor coupled with a processor and a memory. The intelligent noise suppressor receives the voice signal comprising the noise portion(s) and the voice(s) during the media event. Further, the intelligent noise suppressor determines the weightage(s) for the noise portion(s) throughout the media event. Further, the intelligent noise suppressor determines the plurality of parameters associated with the electronic device, where the plurality of parameters includes the preference(s) of the user of the electronic device and the current context of the electronic device. Further, the intelligent noise suppressor suppresses the noise portion(s) in the voice signal based on the weightage(s) and the plurality of parameters associated with the electronic device. Further, the intelligent noise suppressor generates the media file, where the media file includes the voice(s) and non-suppressed noise portion(s).

Unlike existing methods and systems, the proposed method allows the electronic device to selectively suppress the noise portion(s) from the media event (e.g. voice call, video call, recording event, etc.) based on the weight(s) for each noise portion. The weight(s) for each noise portion is updated based on a plurality of parameters associated with an electronic device. The plurality of parameters includes, but is not limited to, a preference of a user of the electronic device, and a current context of the electronic device. As a result, the user's auditory experience enhances during the media event.

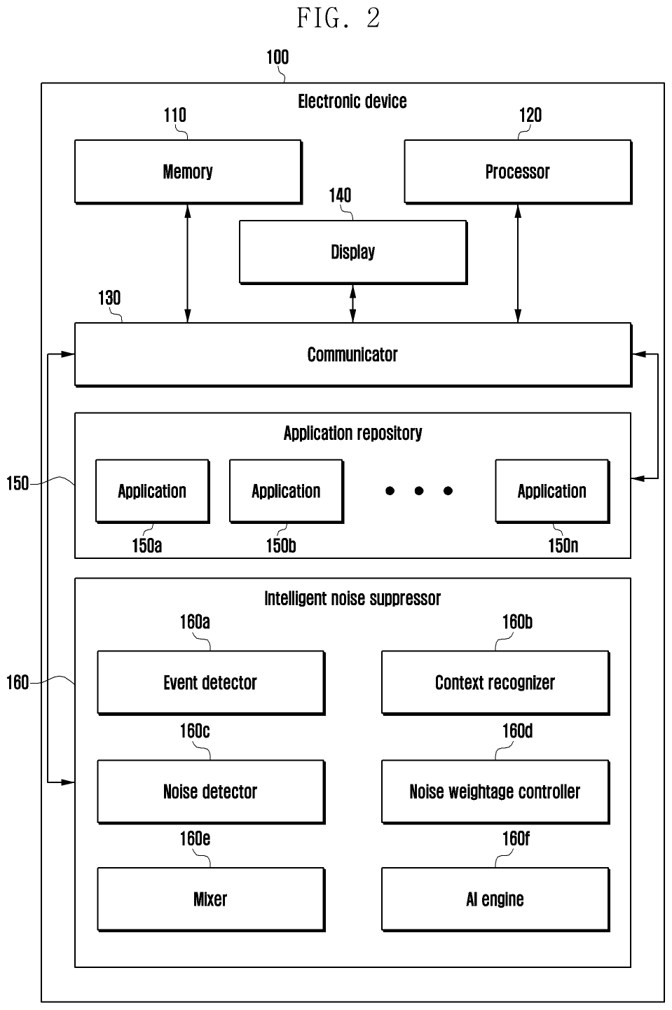

Referring now to the drawings, and more particularly to FIGS. 2, 3, 4A, 4B, 5A to 5D, 6, 7, and 8, where similar reference characters denote corresponding features consistently throughout the figures, there are shown preferred embodiments.

FIG. 2 illustrates a block diagram of an electronic device (100) for suppressing a noise portion(s) from a media event, according to an embodiment of the disclosure. Examples of the electronic device (100) include, but are not limited to a smartphone, a tablet computer, a personal digital assistance (PDA), an internet of things (IoT) device, a wearable device, etc.

In an embodiment, the electronic device (100) includes a memory (110), a processor (120), a communicator (130), a display (140), an application repository (150), and an intelligent noise suppressor (160).

In an embodiment, the memory (110) stores a plurality of parameters including a preference of a user of the electronic device (100) (e.g. history or behavior of the user) and a current context of the electronic device (100) (e.g. image-frame or audio associated with the media event), weightage(s) (or said probability to pass or suppress) for the noise portion(s), updated weightage for the noise portion(s), a plurality of noise categories (e.g. human voice, traffic-noise, etc.), and a pre-loaded weightage(s). The memory (110) stores instructions to be executed by the processor (120). The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information than the memory. In certain examples, a non-transitory storage medium may store data that can, over time, change (e.g., in random access memory (RANI) or cache). The memory (110) can be an internal storage unit or it can be an external storage unit of the electronic device (100), a cloud storage, or any other type of external storage.

The processor (120) communicates with the memory (110), the communicator (130), the display (140), the application repository (150), and the intelligent noise suppressor (160). The processor (120) is configured to execute instructions stored in the memory (110) and to perform various processes. The processor (120) may include one or a plurality of processors, maybe a general-purpose processor, such as a central processing unit (CPU), an application processor (AP), or the like, a graphics-only processing unit such as at least one of a graphics processing unit (GPU), a visual processing unit (VPU), or an artificial intelligence (AI) dedicated processor such as a neural processing unit (NPU).

The communicator (130) is configured for communicating internally between internal hardware components and with external devices (e.g. server, another electronic device, etc.) via one or more networks (e.g. radio technology). The communicator (130) includes an electronic circuit specific to a standard that enables wired or wireless communication. The application repository (150) can include applications 150a, 150b, . . . 150n, for example, but not limited to a camera application, a call application, a business application, an education application, a lifestyle application, an entertainment application, a utility application, a travel application, a health-fitness application, a food application, etc.

The intelligent noise suppressor (160) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the intelligent noise suppressor (160) includes an event detector (160a), a context recognizer (160b), a noise detector (160c), a noise weightage controller (160d), a mixer (160e), and an AI engine (1600.

In an embodiment, the event detector (160a) detects at least one of a user input on the electronic device (100) or the media event associated with the electronic device (100). Example of the user input includes a touch on the display (140), a voice command, and a gesture input. Example of the media event includes a voice call, a video call, a voice over internet protocol (VoIP) call, a voice over long-term evolution (Vo-LTE) call, a voice recording event, and a video recording event. The event detector (160a) notifies the context recognizer (160b), the noise detector (160c), the noise weightage controller (160d), the mixer (160e), and the AI engine (1600 about detecting the user input and the media event associated with the electronic device (100).

In an embodiment, the context recognizer (160b) determines the current context of the electronic device (100) using AI engine (1600. The current context includes location information (e.g. global positioning system (GPS) information, internet protocol (IP) address information), audio information (e.g. human voice, traffic-noise), and visual information (e.g. a plurality of objects displayed on the screen of electronic device or said in displayed image frame) present in the media event. The current context of the media event is determined by the AI engine (160e). The location information is critical for detecting the noise portion from the media event. The location information adds context to determine whether particular noises should be permitted or suppressed. Certain noises are important in various environments.

For example, guitar and music noises may have a higher probability or weightage of being permitted in a home location versus an office or outdoor location. Similarly, background sounds of conversing may be permitted in a home location (where family members are discussing together) but should be prohibited in an outdoor location (where unknown people may be speaking in the background).

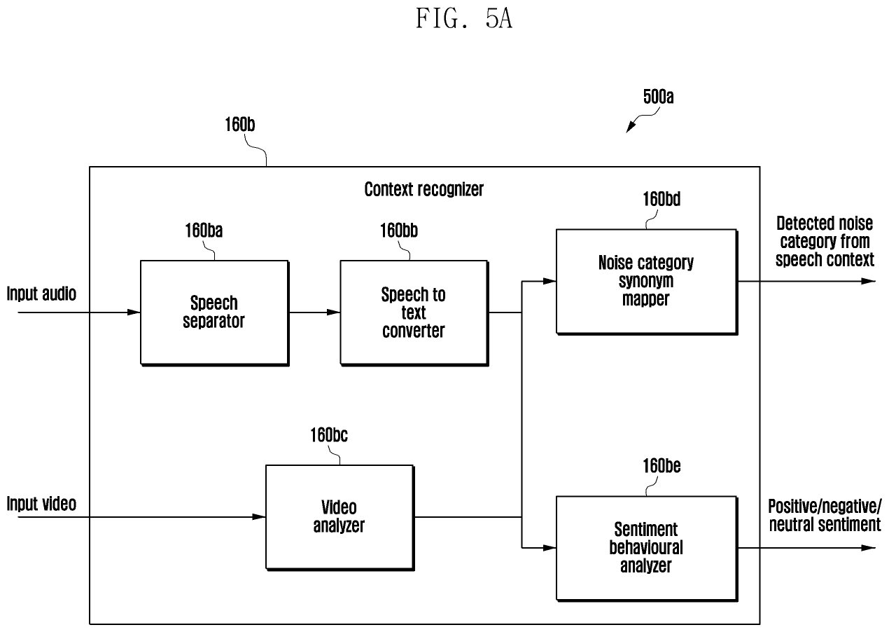

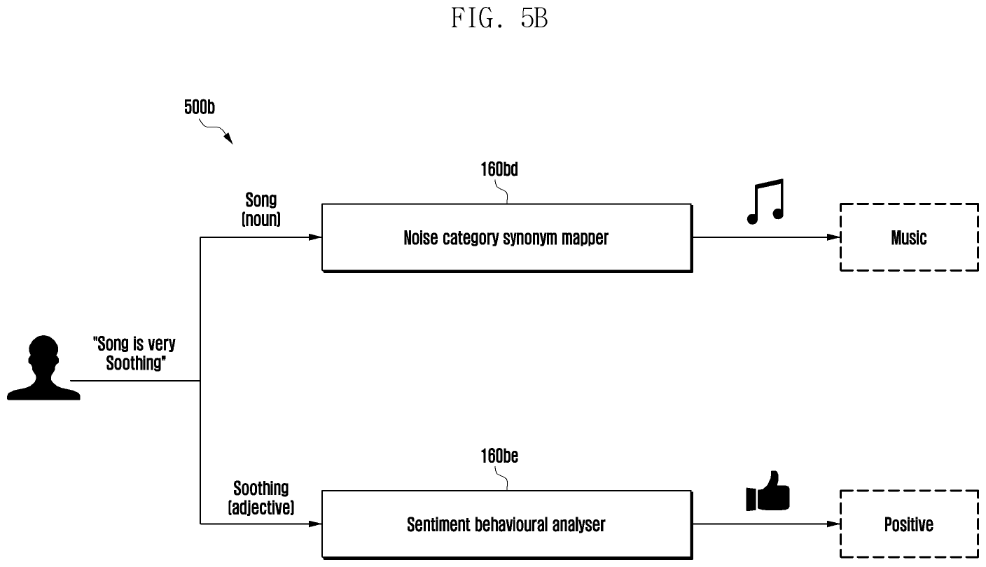

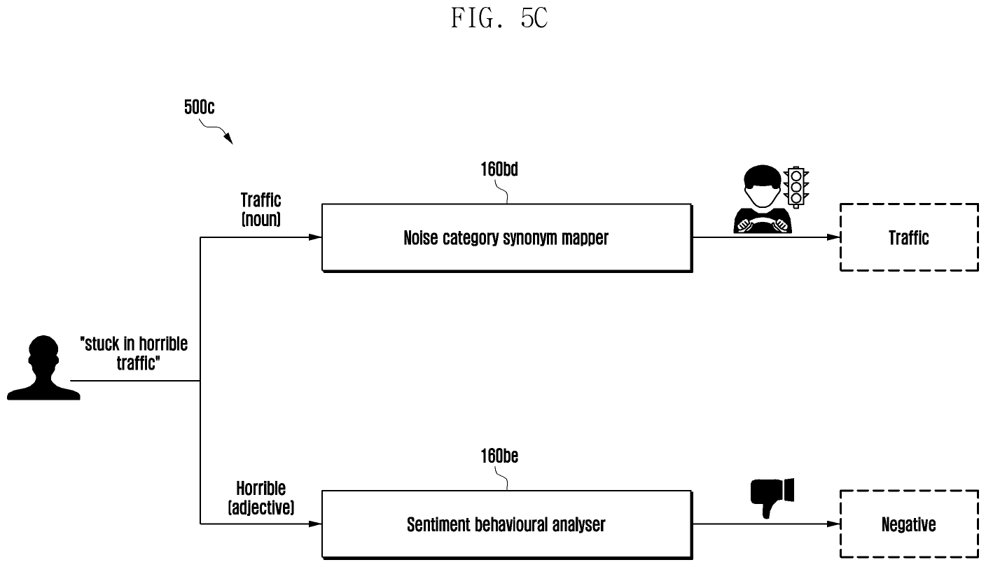

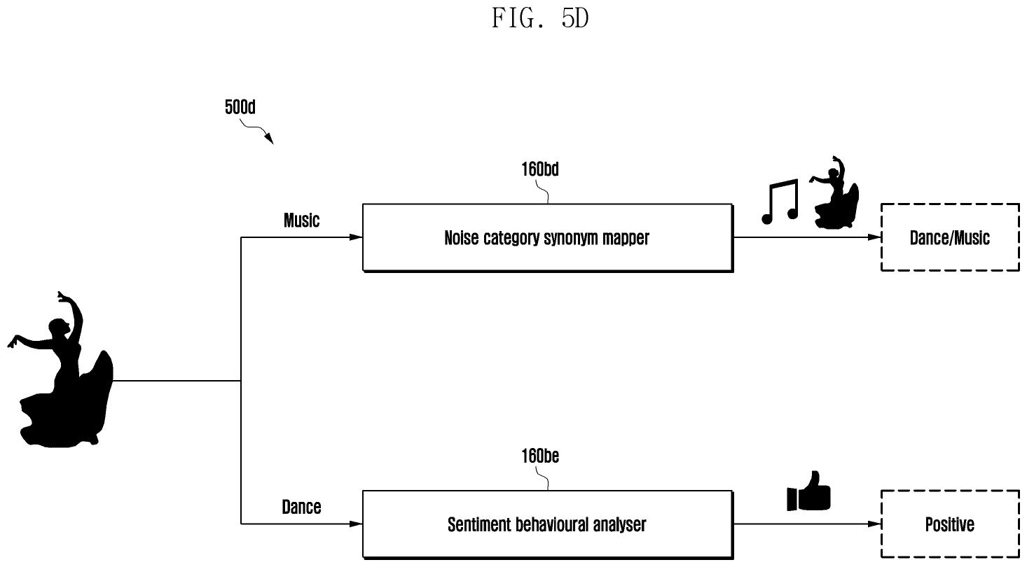

In another scenario, if a second or remote user is present in a certain location where the noise originated, the second or remote user will not knowingly share the guitar sound with the first user who is in the office location. The intelligent noise suppressor (160) determines the first user's location based on the GPS information of the electronic device (100) and the IP address information of the electronic device (100), and it determines the second user's location in a variety of methods. Consider noise mixing as one possibility. For example, if the mixer grinder (or said category of kitchen-noise) is audible, which indicates that the second user is at the home location. The same is true for background television and the presence of vacuum cleaner noise. Similarly, visual cues might aid in comprehending remote location characteristics. So, the intelligent noise suppressor (160) considers location information when making a probability or weightage generation, further detailed explanation is given in FIGS. 5A to 5D.

In an embodiment, the noise detector (160c) receives the voice signal, the voice signal includes the noise portion(s) and the voice. The noise detector (160c) detects or separates the noise portion(s) from the received voice signal throughout the media event.

In an embodiment, the noise weightage controller (160d) maps the noise portion(s) occurring throughout the media event to the one or more noise categories. Furthermore, the noise weightage controller (160d) assigns the weightage(s) for each noise portion(s) of the determined noise portion(s) based on the pre-loaded weightage(s) and the mapping, where the pre-loaded weightage(s) is stored in a database of the electronic device (100).

Furthermore, the noise weightage controller (160d) updates the determined weightage(s) for each noise portion(s) based on the plurality of parameters. The plurality of parameters includes the preference of the user of the electronic device (100) and the current context of the electronic device (100). The preference of the user of the electronic device (100) includes the behavior of the user of the electronic device (100) and the user input of the electronic device (100), and the current context of the electronic device (100) includes the location information, the audio information, and the visual information present in the media event. Furthermore, the noise weightage controller (160d) suppresses the noise portion(s) in the voice signal based on the updated weightage(s) and the plurality of parameters associated with the electronic device (100). Furthermore, the noise weightage controller (160d) stores updated weightage(s) into the database of the electronic device (100).

Furthermore, the noise weightage controller (160d) increases or decreases a value of the weightage(s) for the noise portion(s) based on the plurality of parameters associated with the electronic device (100). Furthermore, the noise weightage controller (160d) increases or decreases the value of the weightage(s) for the noise portion(s) based on the mapping and the pre-loaded weightage(s).

Furthermore, the noise weightage controller (160d) suppresses the noise portion(s) when the value of the weightage(s) for the noise portion(s) is below a predefined threshold (e.g. Table 1). Furthermore, the noise weightage controller (160d) passes the noise portion(s) to the mixer (160e) when the value of the weightage(s) for the noise portion(s) is above the predefined threshold. An example of the predefined threshold is given in Table 1.

TABLE 1

| | Initial | |
|---|---|---|
| Noise category | weightage | Noise portion examples |
| Default allowed | 0.6 | Kids sound, crying, |
| | | background music or songs |
| Default suppressed | 0.4 | Traffic, construction, siren, |
| | | ambient, kitchen |
| Default threshold | 0.5 | Television in the |
| | | background, animal or pets, |
| | | people in the background |

Each noise category is assigned with an initial weight based on which that noise has to be disabled or enabled. The assigned weights of each noise category have a range between 0 and 1, beyond which the weightage does not increase or decrease. For example, the predefined threshold value is set for 0.5. When the value of the weightage(s) of the noise portion is greater than and equal to the predefined threshold, then the intelligent noise suppressor (160) allows the noise category with the speech (or said the mixer (160e) merges the allowed noise portion(s) or noise category with the one or more voices). When the value of the weightage(s) of the noise portion is less than the predefined threshold, then the intelligent noise suppressor (160) restricts the particular noise category (or said the mixer (160e) does not merge the restricted noise portion(s) or noise category with the one or more voices).

For example, the initial weightage(s) of default allowed noises are equal to 0.6 (allowed by default by the user or said based on at least one of the user profile, behavior, or history). The allowed noises are not denoised by the electronic device (100), and they will be automatically suppressed only after being manually or logically disabled by the user multiple times. The initial weightage(s) of default disabled noises are equal to 0.4 (blocked by default by the user). The disabled noises are always suppressed or denoised by the electronic device (100), unless the user allows them multiple times. The initial weightage(s) of default threshold noises are equal to 0.5 (threshold allowed by default). The threshold allowed noises are not denoised by the electronic device (100), but the intelligent noise suppressor (160) learns to denoise them if the user asks them even once.

Furthermore, the noise weightage controller (160d) suppresses the noise portion(s) based on the user input of the electronic device (100), where the user input enables or disables the noise portion(s) and a list of the noise portion(s) and the voice displayed on the screen (140) of the electronic device (100). The user input has a highest priority followed by the location information, followed by the audio information and the visual information of the media event, followed by the user behavior.

In an embodiment, the mixer (160e) merges the passed noise portion(s) with the one or more voices and generates a media file, where the media file includes the passed noise portion(s) (or said non-suppressed noise portion(s)) with the one or more voices.

In an embodiment, the AI engine (1600 may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

A function associated with the AI engine (1600 may be performed through memory (110) and the processor (120). The one or a plurality of processors controls the processing of the input data in accordance with a predefined operating rule or AI model (or said AI engine (1600) stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may at least one of be performed in a device itself in which AI according to an embodiment is performed, or may be implemented through a separate server or system.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Although the FIG. 2 shows various hardware components of the electronic device (100) but it is to be understood that other embodiments are not limited thereon. In other embodiments, the electronic device (100) may include a lessor or greater number of components. Further, the labels or names of the components are used only for illustrative purpose and does not limit the scope of the disclosure. One or more components can be combined together to perform same or substantially similar function for suppressing the noise portion(s) from the media event by the electronic device (100).

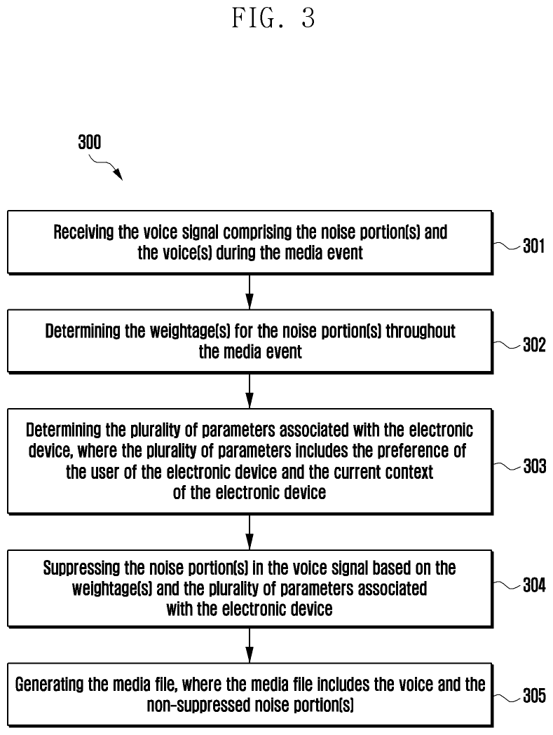

FIG. 3 is a flow diagram (300) illustrating the method for suppressing the noise portion(s) from the media event, according to an embodiment of the disclosure. The electronic device (100) performs various operations (301 to 305) for suppressing the noise portion(s) from the media event.

At operation 301, the method includes receiving the voice signal comprising the noise portion(s) and the voice(s) during the media event. At operation 302, the method includes determining the weightage(s) for the noise portion(s) throughout the media event. At operation 303, the method includes determining the plurality of parameters associated with the electronic device (100), where the plurality of parameters includes the preference of the user of the electronic device (100) and the current context of the electronic device (100). At operation 304, the method includes suppressing the noise portion(s) in the voice signal based on the weightage(s) and the plurality of parameters associated with the electronic device (100). At operation 305, the method includes generating the media file, where the media file includes the voice and the non-suppressed noise portion(s).

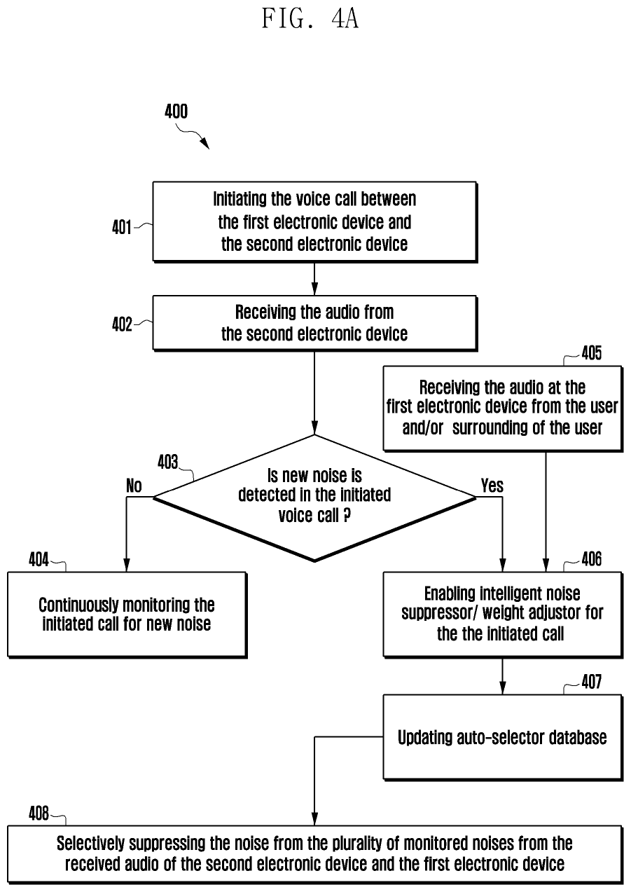

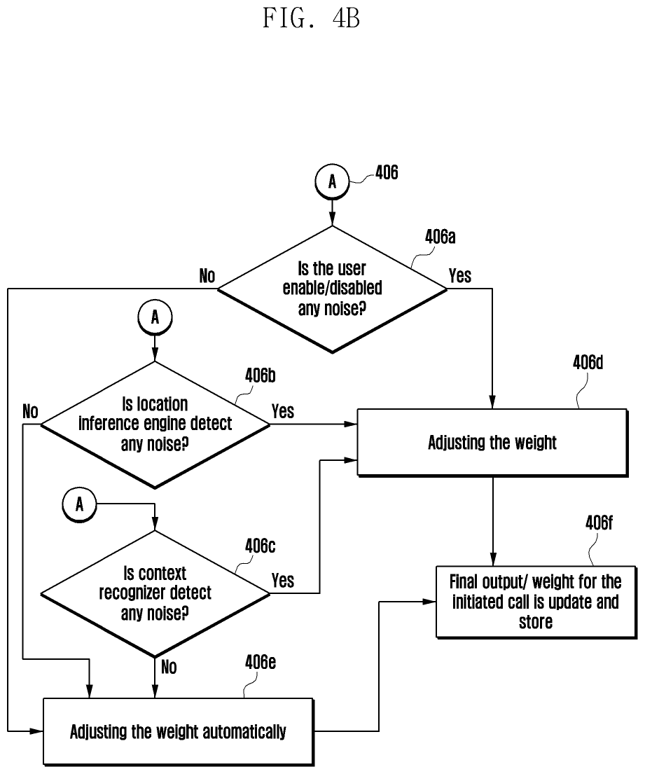

FIGS. 4A and 4B are example flow diagrams (400, 406) illustrating the method for suppressing the noise portion(s) from an ongoing call (e.g. voice call, video call, etc.) by utilizing the AI model of the electronic device (100), according to various embodiments of the disclosure.

Referring to FIG. 4A, at operation 401, the method includes initiating the voice call or video call between the first electronic device (100a) and the second electronic device (100b). At operation 402, the method includes receiving, by the first electronic device (100a), a second audio associated with the voice call or video call from the second electronic device (100b). At operation 403, the method determines whether a new noise (or said new noise portion, whose weight has not previously been stored in the memory or database of the first electronic device (100a)) is recognized in the initiated voice call or video call, where the new noise is associated with the received second audio of the second electronic device (100b). At operation 404, the method includes continuously monitoring, by the first electronic device (100a), the initiated voice call or video call for the new noise in response to determining that the new noise is not recognized in the initiated voice call or video call.

At operation 405, the method includes receiving, by the first electronic device (100a), a first audio associated with the user of the first electronic device (100a) (or said surrounding sound of the user). At operations 406 and 407, the method includes generating, by the first electronic device (100a), the weight for each noise portion of the determined noise portion throughout the voice call or video call in response to determining that the new noise is recognized in the initiated voice call or video call, and updating, by the first electronic device (100a), the generated weight for each noise portion (or said auto selector database) based on the plurality of parameters. At operation 408, the method includes selectively suppressing, by the first electronic device (100a), the new noise (or said noise present in the first audio and the second audio) based on the preference of the user of the first electronic device (100a) and the current context of the first electronic device (100a), from the initiated voice call or video call.

Referring to FIG. 4B, operations 406a through 406f represent details of the operation 406 of FIG. 4A. At operations 406a to 406d, the method includes determining whether the user of the first electronic device (100a) manually enables or disables any noise portion or noise category (e.g. sound of a musical instrument, sound of an animal, etc.) from the list of the noise portion which is displayed on the screen (140) of the first electronic device (100a) during the ongoing voice call or video call. Furthermore, the method includes updating or adjusting the weight for the noise portion based on the manual selection or override feature of the first electronic device (100a) in response to determining that the user of the first electronic device (100a) manually enables or disables any noise portion or noise category. The manual override feature has the highest priority, and no other option can override it. For future calls, the manual override feature additionally causes the highest weight increment or decrement for the noise portion or noise category.

At operations 406b to 406d, the method includes determining whether any noise portion or noise category is detected during the ongoing voice call or video call due to the location information associated with the first electronic device (100a) and the second electronic device (100b). Furthermore, the method includes updating or adjusting the weight for the noise portion based on the location information in response to determining that any noise portion or noise category is detected during the ongoing voice call or video call due to the location information.

At operations 406c and 406d, the method includes determining whether any noise portion or noise category is detected during the ongoing voice call or video call due to the audio information (e.g. speech context) and the visual information (e.g. dance, surrounding ambiance) present in the ongoing voice call or video call. Furthermore, the method includes updating or adjusting the weight for the noise portion based on the audio information and the visual information.

At operation 406e, the method includes updating or adjusting the weight for the noise portion based on the behavior of the user of the first electronic device (100a) (or said user profile) in response to determining that any noise portion or noise category is not detected during the ongoing voice call or video call due to the user input, the location information, the audio information and the visual information. At operation 406f, the method includes storing the updated weight in the memory or database of the first electronic device (100a) for at least one of the ongoing voice call or video call, or at end of voice call or video call.

The various actions, acts, blocks, operations, or the like in the flow diagrams (300, 400, and 406) may be performed in the order presented, in a different order, or simultaneously. Further, in some embodiments, some of the actions, acts, blocks, operations, or the like may be omitted, added, modified, skipped, or the like without departing from the scope of the disclosure.

FIG. 5A illustrates a block diagram (500a) of the context recognizer (160b) of the electronic device (100) for determining the category of the noise portion(s) and a sentiment associated with the current context of the electronic device (100), according to an embodiment of the disclosure.

The context recognizer (160b) includes a speech separator (160ba), a speech to context converter (160bb), a video analyzer (160bc), a noise category synonym mapper (160bd), and a sentiment behavioral analyzer (160be).

The speech separator (160ba) receives input audio (or said sent audio or received audio) at the electronic device (100). The speech separator (160ba) then separates the speech information and the background noise from the received audio using any exiting noise removal mechanism and passes the speech information to the speech to context converter (160bb). The speech to context converter (160bb) converts the speech information to text information (speech context) using any exiting speech conversion mechanism. The video analyzer (160bc) receives an input video (or said sent video or received video) at the electronic device (100) and analyzes visual context based on the received input video.

The noise category synonym mapper (160bd) then maps the speech context to the noise categories based on the text information and the visual context from the received input video. For example, if the speech context or conversation is about “on being in road and irritated by vehicle horns”, the noise category synonym mapper (160bd) maps the speech context “vehicle horns” to one of the known noise categories by using the AI engine (1600, in this example, “traffic noise”. The sentiment behavioral analyzer (160be) maps to the sentiment based on the text information and the visual context from the received input video by using the AI engine (1600 and then adjust the weight accordingly, the sentiment includes a positive, a negative, and a neutral. For example, if the speech context or conversation is about “on being in road and irritated by vehicle horns”, the sentiment behavioral analyzer (160be) maps the “irritated” to “negative”.

FIGS. 5B, 5C, and 5D are example scenarios illustrating functionality of the context recognizer, according to various embodiments of the disclosure.

Consider an example scenario (500b) in which the electronic device (100) receives input audio, for example, “song is very soothing”, from the user of the electronic device (100). The speech separator (160ba) then separates the speech information and the background noise from the received audio. The speech to context converter (160bb) converts the speech information to text information (speech context). The noise category synonym mapper (160bd) then maps the speech context to the noise categories based on the text information (e.g. song as a noun). For example, if the speech context or conversation is about “song is very soothing”, then the noise category synonym mapper (160bd) maps the “song” to one of the known noise categories, in this example, “music”. The sentiment behavioral analyzer (160be) maps to sentiment based on the text information (e.g. soothing as adjective). For example, if the speech context or conversation is about “song is very soothing”, then the sentiment behavioral analyzer (160be) maps the “soothing” to “positive”.

Consider an example scenario (500c) in which the electronic device (100) receives an input audio, for example, “stuck in horrible traffic”, from the user of the electronic device (100). The speech separator (160ba) then separates the speech information and the background noise from the received audio. The speech to context converter (160bb) converts the speech information to text information (speech context). The noise category synonym mapper (160bd) then maps the speech context to the noise categories based on the text information (e.g. traffic as a noun). For example, if the speech context or conversation is about “stuck in horrible traffic”, then the noise category synonym mapper (160bd) maps the “traffic” to one of the known noise categories, in this example, “traffic”. The sentiment behavioral analyzer (160be) maps to sentiment based on the text information (e.g. horrible as adjective). For example, if the speech context or conversation is about “stuck in horrible traffic”, the sentiment behavioral analyzer (160be) maps the “horrible” to “negative”.

Consider an example scenario (500d) in which the electronic device (100) receives an input video from the user of the electronic device (100). The video analyzer (160bc) analyzes a video context (e.g. information associated with multiple image frame) from the received video. The noise category synonym mapper (160bd) then maps the video context to the noise categories based on the video context. The sentiment behavioral analyzer (160be) maps to sentiment based on the video context (e.g. dance), the sentiment behavioral analyzer (160be) maps the “dance” to “positive”.

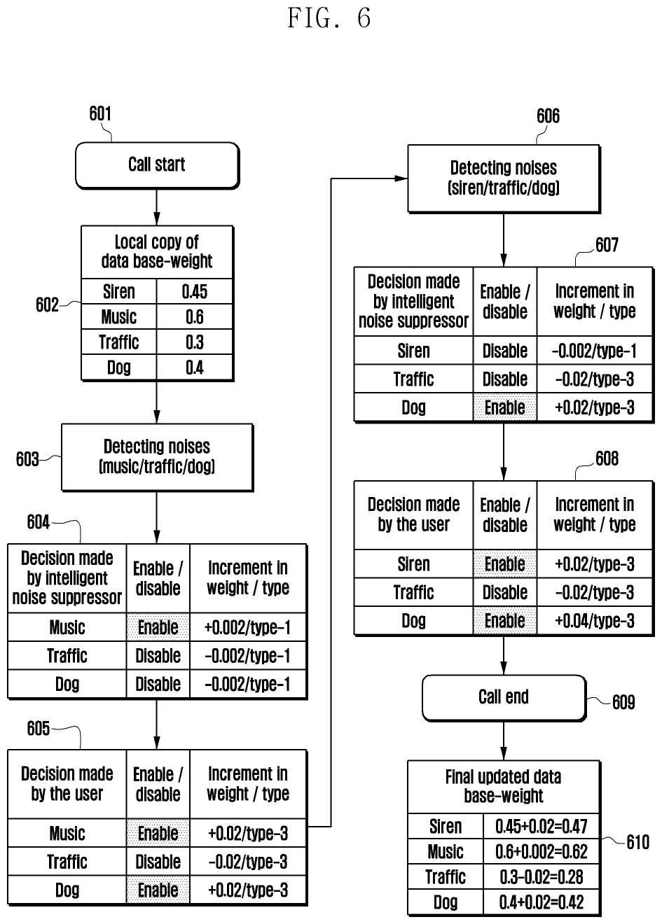

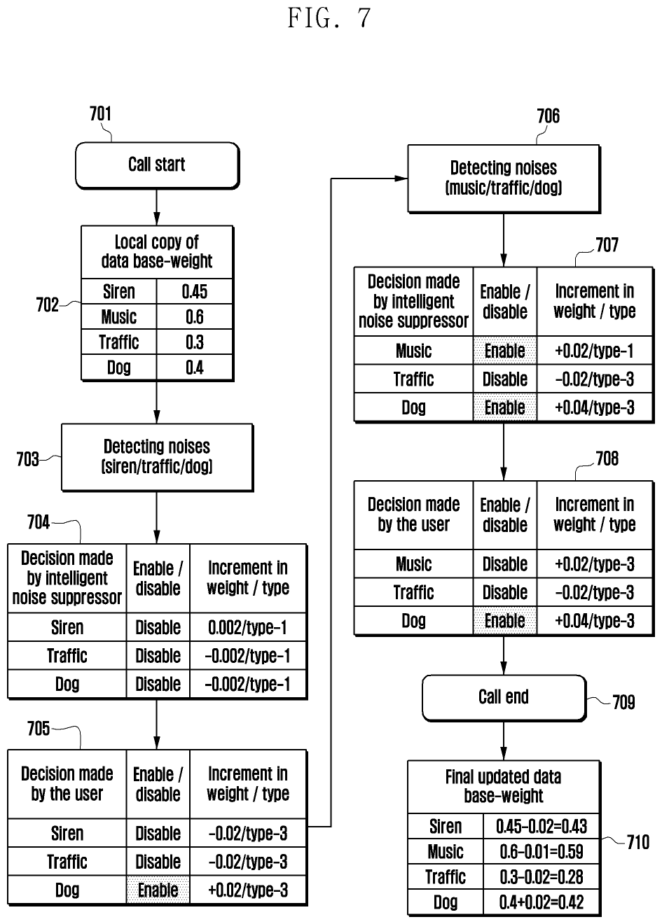

FIGS. 6 and 7 are example scenarios illustrating the weightage(s) generation for each noise portion based on the preference of the user of the electronic device (100), and the current context of the electronic device (100), according to various embodiments of the disclosure.

The weightage(s) increments or decrements based on various types, an example of various types is given in Table 2.

TABLE 2

| | | Weightage(s) increments |
|---|---|---|
| Type | Name | or decrements |
| Type-1 | Automatic | 0.002 |
| Type-2 | Context analyzer | 0.01 |
| Type-3 | Manual override | 0.02 |

Referring to FIG. 6, at 601, the intelligent noise suppressor (160) detects the media event (e.g. call) initiated at the electronic device (100). At 602, the intelligent noise suppressor (160) fetches the stored weightage(s) for each noise portion(s) or category (e.g. siren “0.45”, music “0.6”, traffic “0.3”, and dog “0.4”). At 603, the intelligent noise suppressor (160) detects one or more noise portions (e.g. music, traffic, dog, etc.) in the media event. At 604, the noise portion(s) or categories with the weightage(s) less than 0.5 are default disable (or said pre-load weightage or history of the user) whereas the rest are default enable. The intelligent noise suppressor (160) disables or enables the weightage(s) based on past weightage(s) (or said automatic, Table 2) (e.g. music enables, traffic is disabled and dog is disabled).

At 605, the intelligent noise suppressor (160) receives the user input, where the user of the electronic device (100) manually disables or enables the noise portion(s) or categories and updates the weightage(s) (or said manual override, Table 2).

At 606 and 607, the intelligent noise suppressor (160) again detects one or more noise portions (e.g. siren, traffic, dog, etc.) in the media event. The noise portion(s) or categories with the weightage(s) less than 0.5 are the default disable whereas the rest are the default enable. The intelligent noise suppressor (160) disables or enables the weightage(s) based on the past weightage(s) (or said automatic or manual override, Table 2) (e.g. siren is disabled, traffic is disabled and dog is enabled). At 608, the intelligent noise suppressor (160) again receives the user input, where the user of the electronic device (100) manually disables or enables noise portion(s) or categories and updates the weightage(s) (or said manual override, Table 2). At 609 and 610, the intelligent noise suppressor (160) detects the media event (e.g. call) end, updates the weightage(s) for each noise portion(s) or categories and stores the updated weightage(s) for future media event.

Referring to FIG. 7, at 701, the intelligent noise suppressor (160) detects the media event (e.g. call) initiated at the electronic device (100). At 702, the intelligent noise suppressor (160) fetches the stored weightage(s) for each noise portion(s) or category (e.g. siren “0.45”, music “0.6”, traffic “0.3”, and dog “0.4”). At 703, the intelligent noise suppressor (160) detects the one or more noise portions (e.g. siren, traffic, dog, etc.) in the media event. At 704, the noise portion(s) or categories with the weightage(s) less than 0.5 are the default disable whereas the rest are the default enable. The intelligent noise suppressor (160) disables or enables the weightage(s) based on the past weightage(s) (or said automatic, Table 2) (e.g. siren is disabled, traffic is disabled and dog is disabled).

At 705, the intelligent noise suppressor (160) receives the user input, where the user of the electronic device (100) manually disables or enables the noise portion(s) or categories and updates the weightage(s) (or said manual override, Table 2).

At 706 and 707, the intelligent noise suppressor (160) again detects one or more noise portions (e.g. music, traffic, dog, etc.) in the media event. The noise portion(s) or categories with weightage(s) less than 0.5 are default disable whereas the rest are default enable. The intelligent noise suppressor (160) disables or enables the weightage(s) based on the past weightage(s) (or said automatic or manual override, Table 2) (e.g. music enables, traffic is disabled and dog is enabled). At 708, the intelligent noise suppressor (160) again receives the user input, where the user of the electronic device (100) manually disables or enables the noise portion(s) or categories and updates the weightage(s) (or said manual override, Table 2). At 709 and 710, the intelligent noise suppressor (160) detects the media event (e.g. call) end, updates the weightage(s) for each noise portion(s) or categories and stores the updated weightage(s) for future media event.

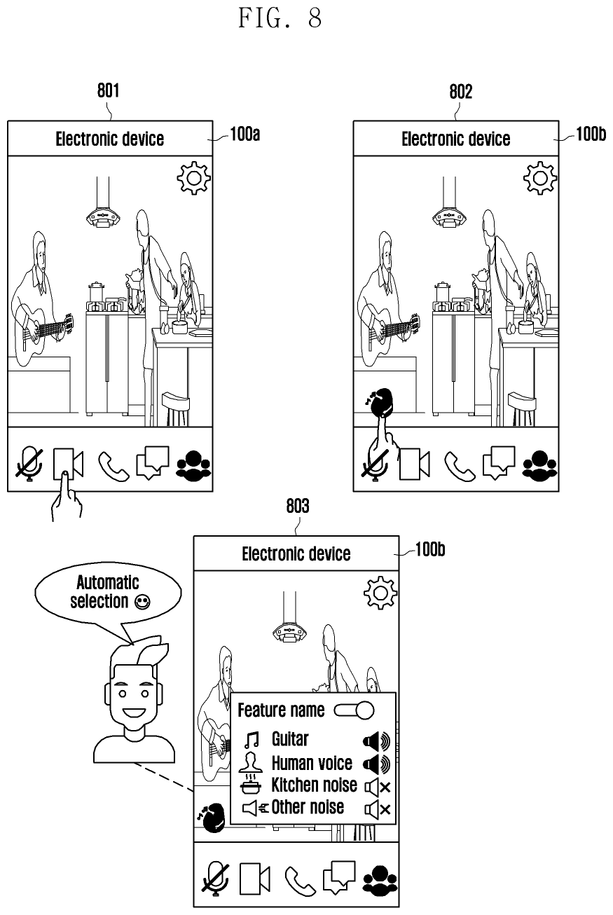

FIG. 8 illustrates an example scenario(s) in which at least one of the electronic device (100) or the user of the electronic device (100) suppress the noise portion(s) from the media event, according to an embodiment of the disclosure.

Consider an example scenario) in which a first user of a first electronic device (100a) streams a live event (e.g. playing guitar at home). At 801, the first user shares the live event with a second user of the second electronic device (100b) through a video call using the first electronic device (100a). At 802, the second electronic device (100b) automatically suppress the noise portion in the voice signal based on the weightage and the plurality of parameters associated with the second electronic device (100b). So, the second user can enjoy the live event or listen a desired sound (e.g. human voice with guitar sound). At 803, the second electronic device (100b) provides the manual sound selection feature(s) to the second user that allows the second user to manually select sound from the list of sounds (e.g. guitar, human voice, kitchen noise, other noise, etc.) displayed on the screen of the second device (100b). As a result, the user's auditory experience enhances during the media event.

The embodiments disclosed herein can be implemented using at least one hardware device and performing network management functions to control the elements.

The foregoing description of the specific embodiments will so fully reveal the general nature of the embodiments herein that others can, by applying current knowledge, readily at least one of modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for suppressing at least one noise portion from a media event by an electronic device, the method comprising:
receiving, by the electronic device, a voice signal comprising the at least one noise portion and at least one voice during the media event;
determining, by the electronic device, at least one weightage for the at least one noise portion throughout the media event;
determining, by the electronic device, a plurality of parameters associated with the electronic device, wherein the plurality of parameters comprises at least one of a preference of a user of the electronic device or a current context of the electronic device;
suppressing, by the electronic device, the at least one noise portion in the voice signal based on the at least one weightage and the plurality of parameters associated with the electronic device; and
generating, by the electronic device, a media file, wherein the media file comprises the at least one voice and at least one non-suppressed noise portion.

2. The method as claimed in claim 1, wherein the suppressing, by the electronic device, of the at least one noise portion in the voice signal based on the at least one weightage and the plurality of parameters associated with the electronic device comprises:
updating, by the electronic device, the at least one determined weightage for each noise portion based on the plurality of parameters; and
suppressing, by the electronic device, the at least one noise portion in the voice signal based on the at least one updated weightage and the plurality of parameters associated with the electronic device.

3. The method as claimed in claim 1,
wherein the preference of the user of the electronic device comprises at least one of a behavior of the user of the electronic device or a user input to the electronic device, and
wherein the current context of the electronic device comprises location information, audio information, and visual information present in the media event.

4. The method as claimed in claim 3, wherein the user input has a highest priority followed by the location information, followed by the audio information and the visual information of the media event, followed by the behavior of the user.

5. The method as claimed in claim 1, wherein the current context of the media event is determined by at least one artificial intelligence (AI) model.

6. The method as claimed in claim 1, wherein the determining, by the electronic device, of the at least one weightage for the at least one noise portion throughout the media event comprises:
detecting, by the electronic device, the at least one noise portion occurring throughout the media event;
mapping, by the electronic device, the at least one noise portion occurring throughout the media event to at least one noise category; and
assigning, by the electronic device, the at least one weightage for each noise portion of the at least one determined noise portion based on a pre-loaded weightage and the mapping, wherein the pre-loaded weightage is stored in a database of the electronic device.

7. The method as claimed in claim 1, wherein the suppressing, by the electronic device, of the at least one noise portion in the voice signal based on the at least one weightage and the plurality of parameters associated with the electronic device comprises:
performing, by the electronic device, at least one of:
increasing a value of the at least one weightage for the at least one noise portion based on the plurality of parameters associated with the electronic device,
decreasing the value of the at least one weightage for the at least one noise portion based on the plurality of parameters associated with the electronic device, or
increasing or decreasing the value of the at least one weightage for the at least one noise portion based on a mapping and a pre-loaded weightage; and
suppressing, by the electronic device, the at least one noise portion based on the increased or decreased value of the at least one weightage by at least one of:
suppressing the at least one noise portion when the value of the at least one weightage for the at least one noise portion is below a predefined threshold, or
suppressing the at least one noise portion based on a user input of the electronic device, wherein the user input enables or disables the at least one noise portion and a list of the at least one noise portion and the at least one voice displayed on a screen of the electronic device.

8. The method as claimed in claim 7, further comprising:
passing, by the electronic device, the at least one noise portion when the value of the at least one weightage for the at least one noise portion is above the predefined threshold; and
merging, by the electronic device, the passed at least one noise portion with the at least one voice.

9. The method as claimed in claim 7, further comprising:
updating, by the electronic device, the value of the at least one weightage for the at least one noise portion based on the plurality of parameters; and
storing, by the electronic device, the updated value of the at least one weightage for the at least one noise portion in a database of the electronic device.

10. The method as claimed in claim 1,
wherein the at least one voice comprises a human voice and a non-human voice, and
wherein the at least one noise portion comprises at least one of the non-human voice, a mixture of human voices, an ambience noise of an office, an ambience noise of a restaurant, an ambience noise of a home, or an ambience noise outdoors on a city street.

11. An electronic device for suppressing at least one noise portion from a media event, the electronic device comprising:
a memory;
a processor; and
an intelligent noise suppressor, operably connected to the memory and the processor, configured to:
receive a voice signal comprising the at least one noise portion and at least one voice during the media event,
determine at least one weightage for the at least one noise portion throughout the media event,
determine a plurality of parameters associated with the electronic device, wherein the plurality of parameters comprises at least one of a preference of a user of the electronic device or a current context of the electronic device,
suppress the at least one noise portion in the voice signal based on the at least one weightage and the plurality of parameters associated with the electronic device, and
generate a media file, wherein the media file comprises the at least one voice and at least one non-suppressed noise portion.

12. The electronic device as claimed in claim 11, wherein the intelligent noise suppressor, to suppress the at least one noise portion in the voice signal based on the at least one weightage and the plurality of parameters associated with the electronic device, is further configured to:
update the at least one determined weightage for each noise portion based on the plurality of parameters; and
suppress the at least one noise portion in the voice signal based on the at least one updated weightage and the plurality of parameters associated with the electronic device.

13. The electronic device as claimed in claim 11,
wherein the preference of the user of the electronic device comprises at least one of a behavior of the user of the electronic device and a user input to the electronic device, and
wherein the current context of the electronic device comprises location information, audio information, and visual information present in the media event.

14. The electronic device as claimed in claim 13, wherein the user input has a highest priority followed by the location information, followed by the audio information and the visual information of the media event, followed by the behavior of the user.

15. The electronic device as claimed in claim 11, wherein the current context of the media event is determined by at least one artificial intelligence (AI) model.

16. The electronic device as claimed in claim 11, wherein the intelligent noise suppressor, to determine the at least one weightage for the at least one noise portion throughout the media event, is further configured to:
detect the at least one noise portion occurring throughout the media event;
map the at least one noise portion occurring throughout the media event to at least one noise category; and
assign the at least one weightage for each noise portion of the at least one determined noise portion based on a pre-loaded weightage and the mapping, wherein the pre-loaded weightage is stored in a database of the electronic device.

17. The electronic device as claimed in claim 11, wherein the intelligent noise suppressor, to suppress the at least one noise portion in the voice signal based on the at least one weightage and the plurality of parameters associated with the electronic device, is further configured to:
perform at least one of:
increasing a value of the at least one weightage for the at least one noise portion based on the plurality of parameters associated with the electronic device,
decreasing the value of the at least one weightage for the at least one noise portion based on the plurality of parameters associated with the electronic device, or
increasing or decreasing the value of the at least one weightage for the at least one noise portion based on a mapping and a pre-loaded weightage; and
suppress the at least one noise portion based on the increased or decreased value of the at least one weightage by at least one of:
suppressing the at least one noise portion when the value of the at least one weightage for the at least one noise portion is below a predefined threshold, or
suppressing the at least one noise portion based on a user input of the electronic device, wherein the user input enables or disables the at least one noise portion and a list of the at least one noise portion and the at least one voice displayed on a screen of the electronic device.

18. The electronic device as claimed in claim 17, wherein the intelligent noise suppressor is further configured to:
pass the at least one noise portion when the value of the at least one weightage for the at least one noise portion is above the predefined threshold; and
merge the passed at least one noise portion with the at least one voice.

19. The electronic device as claimed in claim 17, wherein the intelligent noise suppressor is further configured to:
update the value of the at least one weightage for the at least one noise portion based on the plurality of parameters; and
storing, by the electronic device, the updated value of the at least one weightage for the at least one noise portion in a database of the electronic device.

20. The electronic device as claimed in claim 11,
wherein the at least one voice comprises a human voice and a non-human voice, and
wherein the at least one noise portion comprises at least one of the non-human voice, a mixture of human voices, an ambience noise of an office, an ambience noise of a restaurant, an ambience noise of a home, or an ambience noise outdoors on a city street.

21. The method as claimed in claim 1, wherein the suppressing, by the electronic device, of the at least one noise portion in the voice signal based on the at least one weightage and the plurality of parameters associated with the electronic device comprises:
suppressing the at least one noise portion when the at least one weightage for the at least one noise portion is below a predefined threshold.

22. The electronic device as claimed in claim 11, wherein the intelligent noise suppressor, to suppress the at least one noise portion in the voice signal based on the at least one weightage and the plurality of parameters associated with the electronic device, is further configured to:
suppress the at least one noise portion when the at least one weightage for the at least one noise portion is below a predefined threshold.
